(19) United States
(12) Patent Application Publication
(10) Pub. No.: US 2015/0156146 A1
(43) Pub. Date: Jun. 4, 2015

(54) THREADED MESSAGE HANDLING SYSTEM FOR SEQUENTIAL USER INTERFACES

(71) Applicant: IMS SOLUTIONS, INC., Schaumburg, IL (US)

(72) Inventors: William Ben Miners, Guelph (CA); Robert Andrew Rae, Elmire (CA)

(21) Appl. No.: 14/556,941

(22) Filed: Dec. 1, 2014

Related U.S. Application Data
(60) Provisional application No. 61/910,244, filed on Nov. 29, 2013.

(51) Int. Cl. H04L 12/58

(52) U.S. Cl. CPC H04L 51/046

(57) ABSTRACT

A method for presenting a plurality of messages to a user includes constructing a tree of the plurality of messages, wherein each of the plurality of messages is a different node. Each of the plurality of messages is in one of a plurality of threads in the tree. The nodes representing a subset of the plurality of messages that are already read and their ancestor nodes are designated as do-not-read. A reading order of the plurality of messages is determined by traversing the tree in a depth-first manner while appending a tree separator at each terminal node and skipping any do-not-read nodes. The plurality of messages are then presented to the user based upon the reading order.

### BACKGROUND

This application relates to a threaded messaging handling system that deploys context-aware grouping of messages into “conversation threads” to facilitate fast interaction using sequential interfaces including voice user interfaces (“VUI”).

Conventional approaches to interact with threaded messages in a sequential user interface usually read available messages in reverse chronological order. This approach often involves reading an entire thread of old messages to establish context for the new message(s) and can significantly increase the time required to understand the thread and ultimately slows down the user interaction process.

Moreover, message conversations often fork, e.g. participants may be dropped from the conversation or two (or more) participants may reply to the same message. This makes reconstructing the appropriate context for the messages a challenging task when conveying content through a sequential user interface.

### SUMMARY

A message handling system according to one disclosed embodiment constructs a conversation tree through analysis of the message summaries, subjects, senders, and quoted message content in the thread itself. The tree is then traversed in a specific manner to achieve the fastest interaction time while preserving maximum contextual information across the messages.

The system includes a context-aware message threading approach, as well as the ability to handle the special case of “stray messages,” or messages that are part of a conversation thread but are not present in the user's inbox. These “stray messages” typically occur when the user is part of the message thread for only a portion of the interaction.

In one example embodiment, the messages include emails received in a single account. In other embodiments, the threaded messages may span multiple modes of interaction, both across multiple email accounts and across multiple modes of transport including text messages, email, instant messaging, social networks, and voice mail.

Sequential user interface examples include voice interactive interfaces, where the audible channel conveys a single sequential stream of content, and constrained text interfaces (i.e RDS feeds).

This disclosure provides a system that automatically identifies contextually relevant content from threaded messages. The threaded messages may be within the same mode of communication. The threaded messages may span multiple modes of communication. The threaded messages may contain stray messages. The threaded messages may include one or more of email, text messages, social networks, and instant messenger sources. The ordering of messages may be selected based on historical usage patterns.

This disclosure provides a system to transform relevant content from threaded messages into a sequential form for use in a sequential user interface. The sequential user interface may be a voice user interface. The sequential user interface may be a text-based user interface. The transformation may occur on a mobile device. The user interface may be within a vehicle and the relevant content may depend on the driving and vehicle behavior. The verbosity of the relevant content may be dynamically adjusted based on driving and vehicle behavior.

These and other features of the invention can be best understood from the following specification and drawings.

### BRIEF DESCRIPTION OF THE DRAWINGS

FIGS. 1a-c schematically illustrate the message threading tree without stray messages.

FIG. 2 schematically illustrates a message thread with stray messages.

FIGS. 3a-b schematically illustrate the message threading tree with stray messages that can be linearly inserted into the tree.

FIGS. 4a-c schematically illustrate the message threading tree with stray messages that require tree restructuring.

FIG. 5 schematically illustrates a mobile device which could implement the method described in FIGS. 1-4.

### DETAILED DESCRIPTION OF THE PREFERRED EMBODIMENT

The Basic Message Threading Method

The following section details the four main steps involved in the basic message threading method as the following:
1. Construct a tree of all the messages according to their subject and embedded quoted context. Designate the nodes representing the already read messages as “read.”
2. Mark the nodes previously designated as read, and all of their ancestor nodes, as “do-not-read.” It is assumed that all of the preceding (ancestor) nodes of a read message were also read as a part of the quoted message itself and thus need not to be read again.
3. Restructure the tree by placing the shortest sub-threads left-most, where the length of a sub-thread is determined according to the number of its nodes (messages) that are not marked as “do-not-read.” In case of a tie, place the sub-thread with the most recent message left-most. During presentation, “left-most” means that the sub-thread is presented first, followed by the next left-most, and so on.
4. Compute the reading order of messages by traversing the tree in a depth-first manner while appending a tree separator at each terminal node and skipping the nodes marked as “do-not-read.” “Depth-first” means that each branch is followed to the end before switching to another branch. The tree separator indicates the need to provide an audible or other indicator to the user alerting the user of the shift.

Sample Email Conversation Demonstration

This section presents an exemplary conversation involving several email correspondences as summarized in Table 1.

TABLE 1
Sample Email Conversation.

| Message | Type of | | Time | Marked as Unread |
|---|---|---|---|---|
| id | reply | Sender | received | or Already Read? |
| G | Reply to B | Gina | 6:10 pm | Unread |
| F | Reply to E | Fred | 6:00 pm | Unread |
| E | Reply to D | Edith | 5:00 pm | Unread |
| D | Reply to C | Daniel | 4:00 pm | Unread |
| C | Reply to A | Carol | 2:01 pm | Already read |
| B | Reply to A | Brian | 2:00 pm | Unread |
| A | Original | Adam | 1:00 pm | Unread |
| | Message | | | |

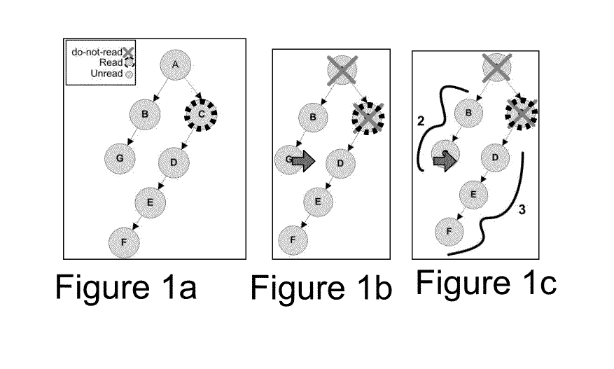

Following the steps of the basic threading method discussed earlier, a tree of messages is first constructed (FIG. 1(a)). Subsequently, node C and its ancestor, node A, are designated as read and thus marked as “do-not-read” (FIG. 1(b)). Lastly, two sub-threads containing nodes {B G}, and nodes {D E F}, respectively, are identified and the resultant tree is traversed (FIG. 1(c)). The sub-thread of {B G} is placed left-most as it is shorter and also contains the most recent message G. The reading is computed as {B G//D E F} (the symbol // denotes a thread separator).

The corresponding (voice or sequential interface) dialog with the user for this reading order could proceed as the following:
(a) The first message in the conversation is from Brian, subject is XYZ, email reads <read the email>
(b) What would you like to do? For example: “Go backward” or “Forward in the conversation
   “Forwards”
(c) Next a reply from Gina, It says <read the email>.
(d) That was the last email in this conversation. What would you like? For example, say: “Reply to all”, or, “Next conversation.”
   “Next conversation”
(e) Next, there is a separate conversation, with that same subject XYZ. Here is the first unread reply from Daniel <read the email>.
(f) What would you like to do? For example: “Go backward” or “Forward in the conversation
   “Forwards”
(g) Next a reply from Edith, It says <read the email>.
(h) What would you like to do? For example: “Go backward” or “Forward in the conversation
   “Forwards”
(i) Next a reply from Fred, It says <read the email>.
(j) . . .

Additional Features

This section describes a special feature of the disclosed method. Some messages can be part of a conversation thread and not be present in the user's inbox, i.e. the so-called “Stray nodes.” This could occur in one of the following two cases:
1. The user has deliberately deleted the message,
2. The user has been forwarded or copied on a message, e.g. a “FYI email.”

The aforementioned two cases are differentiated via examining both the subject and recipient fields of an email. More specifically, the email is considered to belong to the case 1 if the given user has been one of its recipients. Once differentiated, the cases 1 and 2 are handled as described in the following, respectively:
1. The email in question is inserted in the appropriate location in the tree and designated as read; consequently designating all of its ancestors as read, i.e. marked as “do-not-read”. The tree is traversed as normal.
2. A subtree containing the email in question and all of the quoted emails is constructed and appended to the tree in the appropriate location. None of the nodes in the subtree are designated as read, i.e. they are all included in the reading order, except for the email nodes that already appear in the inbox, which are removed. The subtree is traversed in the same manner as the main tree.

Sample Dialogue Involving Stray Nodes

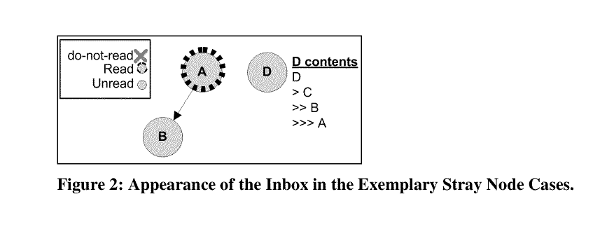

This section presents two exemplary cases of stray node processing to further elaborate on the behavior of the proposed method. FIG. 2 shows the appearance of the inbox with emails A, B, and D being in the inbox, and email D containing the quoted emails A, B, and C.

Case 1 Behavior

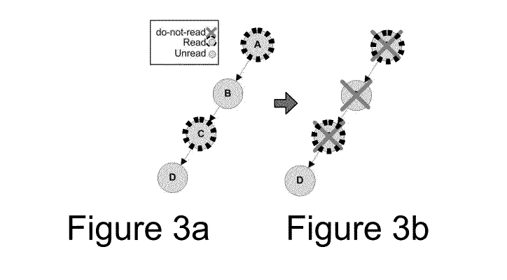

In this case (illustrated in FIG. 3) the user was a recipient of email C, and thus is assumed to have read it. A node representing email C is added to the tree in the appropriate place as shown in FIG. 3(a). Consequently, node C and all of its ancestors are designated as read, i.e. marked as “do-not-read” (FIG. 3(b)), resulting in the reading order to be {D}.

Case 2 Behavior

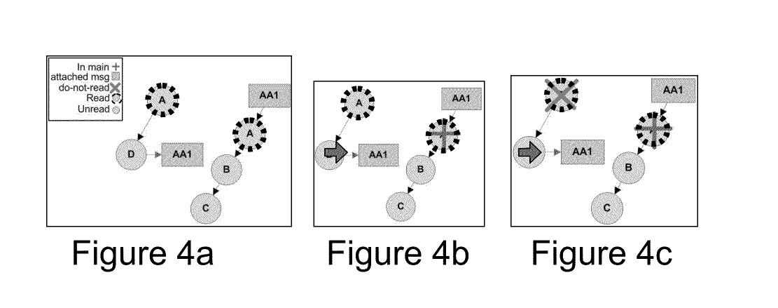

In this case (illustrated in FIGS. 3 and 4) the user was not a recipient of email C, the user is being forwarded an email. A subtree is containing all of the quoted emails is constricted (FIG. 4(a)). The email A that appears in both the subtree and the inbox is removed from the subtree (FIG. 4(b)). To compute the reading order the main tree is traversed as normal. However, when reaching the email D that contains the quoted information, the corresponding subtree is traversed using the same traversal algorithm as the main tree (FIG. 4(c)). The resultant reading order then starts with email D, followed by informing user of the existence of a quoted email, and finally reading emails B and C, i.e. {D//B C}.

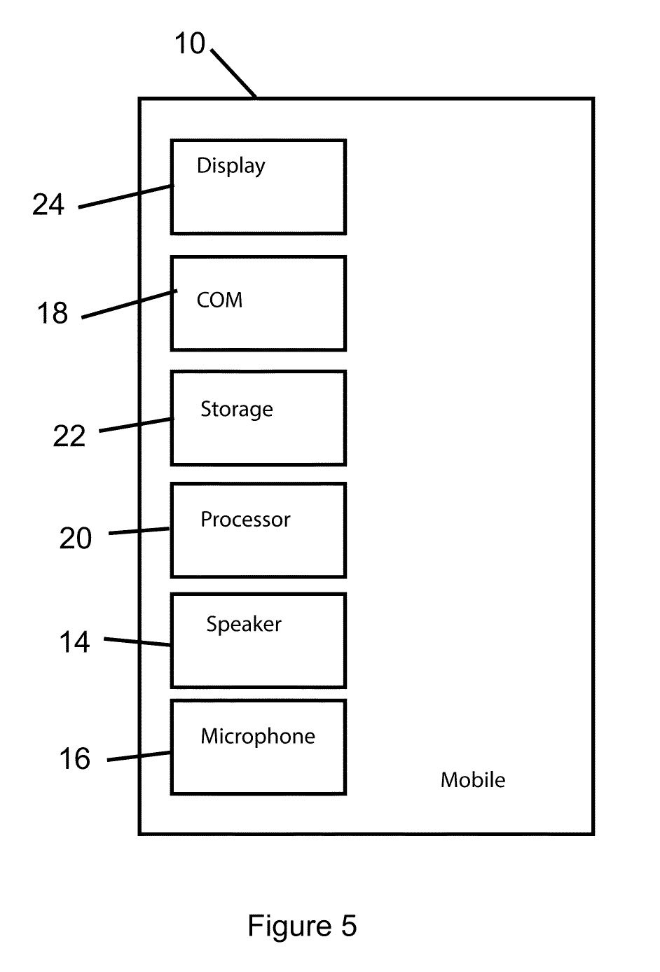

FIG. 5 schematically illustrates one example of hardware that could perform the methods described above. In this particular example, the hardware is a mobile device 10, such as a cell phone. The mobile device 10 includes a speaker 14 and microphone 16 for providing voice communication and which may also provide voice commands to the mobile device 10 from the user and may provide audible prompts and information to the user from the mobile device 10. The mobile device 10 includes communication circuitry 18, such as the cell phone circuitry (voice and data), and may also include local communication circuitry such as wi-fi, Bluetooth, etc. A processor 20 (which may be more than one processor and/or more than one core) is programmed to perform the methods described above, including retrieving and analyzing messages, determining the read order of the messages and generating audible presentations of the messages. Onboard storage 22 (such as electronic, magnetic, optical, etc storage), stores programs which when executed by processor 20 perform the methods described herein, and may store the user's inbox while it is analyzed by the processor 20. The mobile device 10 may also include a display 24, such as a touch screen display 24, as part of a user interface.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for presenting a plurality of messages to a user including the steps of:
a) constructing a tree of the plurality of messages, wherein each of the plurality of messages is a different node, each of the plurality of messages in one of a plurality of threads in the tree;
b) designating as do-not-read the nodes representing a subset of the plurality of messages that are already read and ancestor nodes of the subset of plurality of messages;
c) determining a reading order of the plurality of messages by traversing the tree in a depth-first manner while appending a tree separator at each terminal node and skipping any do-not-read nodes; and
d) presenting the plurality of messages to the user based upon the reading order.

2. The method of claim 1 wherein said step c) further includes the step of ordering shorter threads before longer threads.

3. The method of claim 2 wherein said step c) further includes the step of ordering threads with a more recent message before other threads.

4. The method of claim 3 wherein said step d) includes skipping messages represented by do-not-read nodes.

5. The method of claim 1 wherein said step d) includes the step of presenting the plurality of messages to the user audibly.

6. The method of claim 1 further including the steps of:
e) determining that a first message of the plurality of messages is not present;
f) determining that the user has deliberately deleted the first message; and
g) based upon said steps e) and f), inserting the first message into the tree and designating the first message and ancestors of the first messages as do-not-read.

7. The method of claim 1 further including the steps of:
e) determining that a first message of the plurality of messages is not present;
f) determining that the user was not a recipient of the first message; and
g) based upon said steps e) and f), appending the first message into the tree and presenting the first message in said step d).

8. The method of claim 7 wherein said step d) includes the step of presenting the plurality of messages, including the first message, to the user audibly.

9. An email system including:
a processor programmed to construct a tree of the plurality of messages, wherein each of the plurality of messages is a different node, each of the plurality of messages in one of a plurality of threads in the tree, the processor programmed to designate do-not-read the nodes representing a subset of the plurality of messages that are already read and ancestor nodes of the subset of plurality of messages; the processor determined a reading order of the plurality of messages by traversing the tree in a depth-first manner while appending a tree separator at each terminal node and skipping any do-not-read nodes, the processor programed to present the plurality of messages to the user based upon the reading order.
